(19) United States
(12) Patent Application Publication
(10) Pub. No.: US 2021/0170620 A1
(43) Pub. Date: Jun. 10, 2021

(54) METHOD AND APPARATUS FOR PROCESSING CUTTING-CREASING RULES OF DIE-CUTTERS

(71) Applicant: Pro Form S.r.l., Caravaggio (IT)

(72) Inventors: Roberto Spairani, Caravaggio (IT); Secondo Spairani, Caravaggio (IT)

(21) Appl. No.: 17/267,798

(22) PCT Filed: Jul. 4, 2019
(86) PCT No.: PCT/IB2019/055710

§ 371 Date: Feb. 10, 2021

(30) Foreign Application Priority Data
Aug. 13, 2018 (IT) 102018000008081

(51) Int. Cl. B26F 1/44; B21D 28/06

(52) U.S. Cl. CPC B26F 1/44; B31B 50/252; B21D 28/06

(57) ABSTRACT

A method and apparatus which allow cutting-creasing rules (1) for die-cutters to be obtained from sections of cutting rules and sections of creasing rules are described. In particular, the method comprises: ⋅ (a) from a cutting rule (13) for die-cutters having height H, separating sections (2′, 2″, 2′″) provided with a cutting edge (4) and provided with coupling means (9, 10) to obtain an interlocked coupling (8) with other sections (3′, 3″, 3′″) of a creasing rule (14), ⋅ (b) from a creasing rule (14) for die-cutters having height H′, separating sections (3′, 3″, 3′″) provided with a creasing profile (5) and provided with coupling means (11, 12) to obtain an interlocked coupling (8) with other sections (2′, 2″, 2′″) of a cutting rule (13) ⋅ (c) coupling in succession the sections (2′, 2″, 2′″) of the cutting rule (13) to the sections (3′, 3″, 3′″) of the creasing rule (14) until the cutting-creasing rule (1) is obtained, the steps (a) and (b) are not carried out by tools different from each other for the cutting rule (13) and the creasing rule (14), but by the same shearing tool.

### FIELD OF THE INVENTION

The present invention relates to the field of die-cutters and in particular refers to a method and an apparatus for making cutting-creasing rules to be used for assembling die-cutters.

### STATE OF THE ART

As known, a die-cutter used in die-cutting machines comprises a flat or cylindrical support, normally made of multilayer wood, in which metal rules provided with a cutting and/or bending (creasing) profile are assembled; the rules are inserted by interference fit into corresponding seats obtained in the support and are arranged so as to reproduce the shape of a product to be made by die-cutting a sheet of paper or cardboard, for example a box. The seats in the support are generally obtained by laser cutting techniques. The insertion of the rules in the corresponding seats is usually manually carried out by an operator, often with the aid of a hammer.

Raw metal rules are initially unwound and machined, e.g. punched, milled, rounded, bent several times to obtain the desired shapes, and finally cut to size.

Structurally, a typical die-cutter rule comprises a base, which can be orthogonally inserted into the support in a corresponding seat, and an edge facing the side opposite the support, i.e. facing the sheet to be die-cut. The rules have heights extending between the base and the edge facing the sheet to be die-cut. On the support of the die cutter, further elements combined with the rules are also provided, for example elastic elements which facilitate the detachment and separating of the die cut portion of the sheet from the die cutter itself.

The rules are mainly subdivided into cutting rules (blades) and bending or creasing rules (creasing profiles).

In the first type, the rule has a cutting edge, typically with a triangular section, able to cut the sheet to be die-cut when pushed into abutment against the latter and against a counter-male die positioned on the opposite side with respect to the sheet. Cutting rules are used, for example, to make cutting lines that define the perimeter profile of a box.

The bending or creasing rules, on the other hand, have a rounded edge shaped to press, without severing, the sheet against a seat of a counter-male die positioned on the opposite side with respect to the sheet to be die cut. This way, a trace is obtained along which the bending of the sheet is easy. This is the case, for example, of the creasing lines on the flaps of a paper or cardboard box.

Other rules allow the so-named weakening or tear-off lines to be made, i.e. dashed lines which alternate cut lengths with uncut lengths.

A manufacturer of die-cutter rules is, for example, Martin Miller firm (www.martin-miller.com). Die-cutter manufacturers buy the rules and process them in order to obtain the blades, creasing rules and accessories required to make each time the desired die-cutter.

In the paper processing industry, hybrid solutions are sometimes used, i.e. rules called cutting-creasing rules (or cut-crease rules), characterized by alternating cutting lengths, i.e. blades, and creasing lengths, i.e. creasing profiles.

For example, US 2018/178477 describes a cutting-creasing rule obtained by assembling sections of cutting rule and sections of creasing rule, and a method for obtaining such rule. In particular, this document teaches how to make the rule by fit coupling sections of the cutting rule and sections of the creasing rule in the desired sequence, by exploiting a dovetail coupling specifically designed for this (FIGS. 3-6; claim 1). Each section of the rule, whether a cutting one or a creasing one, is provided with either a dovetail profile or a profile shaped as a puzzle piece at its bottom part—the one intended to be inserted into a corresponding seat obtained in the die-cutter support: this arrangement allows the sections to be assembled one to the other, in the desired sequence, until the cutting-creasing rule with the desired pattern of the cutting edge and creasing profile is obtained. The sections of the rules, including the respective dovetail profile or similar profile, are obtained by cutting to size, with shaped tools, continuous cutting rules and continuous creasing rules.

The solution described in US 2018/178477 has been ignored for some time by the paper processing industry, because it involves some difficulties.

In general, the individual sections of the cutting rule and creasing rule must be made very accurately, with tight dimensional tolerances. In fact, all the rule sections must be able to be aligned with extreme precision during the assembly on the die-cutter: the rule sections must not be vertically misaligned with respect to each other, because this would result in an inaccurate die-cutter, or even in an unusable cutting-creasing rule.

In addition, the sections of the cutting rule must have a perfectly straight cutting edge, which means that, when shearing the rules from which the sections are obtained, the corners of the cutting edge of each section of rule must not be bent or damaged at their ends.

Finally, it must be possible that, on request, on the initial and final edges of the creasing profile, the sections of creasing rule have indentations or chamfers, whose dimensions can be set each time.

Generally, the cutting-creasing rules described above are made by using two different shearing tools that produce shaped cuts, one for each type of rule section: the first tool has the function of shearing sections of a cutting rule and the second tool has the function of shearing sections of a creasing rule.

The reason why the manufacturers of apparatuses for processing the rules have been led to use two different shearing tools is that cutting rules and creasing rules usually have different heights.

However, precisely because the rule sections to be assembled are obtained with two different shearing tools, the assembled cutting-creasing rules can probably be imperfect, the rule sections that make it up being not perfectly aligned vertically, due to different mechanical tolerances of the two different shearing tools used to shear the sections.

Another limitation of the current method of making cutting-creasing rules is the fact that the first shearing tool used for the cutting rule can shear sections of the rule having only one specific height: if sections of the cutting rule with different heights are desired, the tool has to be changed.

In addition, in modern molding systems for boxes, a counter plate made of milled steel is used in the crease areas; in these cases, sections of cutting-creasing rule in which the height of the creasing profile is sometimes even greater than that of the cutting blade have to be created. The admissible geometrical tolerances of the sections of cutting-creasing rule must be within values of about 0.03 mm, a value that is difficult to obtain by using two different shearing tools to machine the rule sections to be assembled with one another. US 2016/121507 describes a solution according to the known art.

US 2018/0178477 describes a method for making a cutting-creasing rule for cutting-dies. First, sections are separated from a cutting rule for die-cutters having height H, the sections being provided with a cutting edge and with coupling means to obtain a shape coupling with sections of a creasing rule. Then, sections are separated from a creasing rule for die-cutters having height H′, the sections being provided with a creasing profile and with coupling means to obtain a shape coupling with sections of a cutting rule. Finally, the sections of cutting rule are coupled in succession to the sections of creasing rule until the cutting-creasing rule is obtained.

### SUMMARY OF THE INVENTION

Object of the present invention is therefore to provide a method and an apparatus that allow to overcome the limits of the solutions available today, in particular allow to manufacture cutting-creasing rules having excellent quality, characterized by high dimensional and constructional accuracy.

Therefore, a first aspect of the present invention concerns a method according to claim 1.

In particular, the method comprises:

(a) from a cutting rule for die-cutters having height H, separating sections provided with a cutting edge and provided with coupling means to obtain an interlocked shape-coupling with other sections of a creasing rule;

(b) from a creasing rule for die-cutters having height H′, separating sections provided with a creasing profile and provided with coupling means to obtain an interlocked shape-coupling with other sections of a cutting rule;

(c) coupling in succession the sections of cutting rule to the sections of creasing rule until the cutting-creasing rule is obtained.

Advantageously, steps (a) and (b) are not carried out by tools different from each other for the cutting rule and the creasing rule, but by the same shearing tool, by shearing the rules so as to intercept the upper edges thereof, i.e. by intercepting the cutting edge of the cutting rules and the creasing profile of the creasing rules which are sheared each time. Since the cutting rules and the creasing rules can have same or different heights, this condition can be achieved in two ways.

In a first, complete-shearing mode, the shearing tool intercepts the rules throughout their height, i.e. it protrudes beyond the upper and lower edges of the rules which are each time sheared. Therefore, each time the shearing tool is activated, it separates a section from the respective rule. For example, the shearing tool defines an impression, i.e. the shape of the shaped cut it makes on the rules, whose height H″ is greater than the height H of the cutting rule and greater than the height H′ of the creasing rule, or at least is equal to the greater one between H and H′.

In a second, partial-shearing mode, which is independent of the height H″ of the impression of the shearing tool (which could even be less than the height H of the cutting rule and less than the height H′ of the creasing rule, or at least is equal to the smaller one of the heights H and H′), during the shearing the relative position of the rules with respect to the shearing tool is such that the impression of the shearing tool intercepts the cutting edge of the cutting rule and the cutting edge of the creasing rule, i.e. the impression of the shearing tool protrudes beyond the upper edge of the sheared rules, but does not intercept the lower edge of the rules. In this case, the rule each time subject to shearing is only partially cut, remaining intact at its lower edge, which is not intercepted by the shearing tool and where a connecting portion remains. The separation of the rule sections is completed at a later time, downstream of the shearing tool, for example with shears.

Herein, the expression “height H” of the impression of the shearing tool means the pattern of the impression on a plane, in particular the plane where the rules lie during shearing, along the height of the rules themselves.

The two ways described above allow both cutting rules and the creasing rules to be sheared with the same tool, even when the rules have different heights; since the shearing is performed with the same tool, the precision of execution is the same for the sections of cutting rules and for the sections of creasing rules, i.e. the sections have the same dimensional tolerances even if obtained from different rules. As direct result, by coupling the sections obtained with this method to each other, a cutting-creasing rule of excellent quality is assembled, characterized by precise alignment of the lower edges of all the sections that make it up, and without undesirable vertical misalignments between the sections; the assembly is not only precise, but also requires less time than the solutions used so far, and there is no waste.

Among other things, the proposed solution allows the simplification of the layout of the equipment normally used to shear the sections of the rule, right because it intends to share the same shearing tool for the cutting rules and the creasing rules.

Preferably, steps (a) and (b) are carried out by using the same shearing unit provided with:
a plane for feeding or sliding the cutting rules and the creasing rules,
a shearing tool which can be orthogonally moved with respect to the feed plane, and
a corresponding shearing die into which the shearing tool is inserted.

The shearing tool together with the shearing die define the above-mentioned impression. The impression includes the side edges of the sheared sections, i.e. the side edges of both the sections of the cutting rules and the sections of the creasing rules as well as the respective coupling means.

Preferably, the coupling means include shaped projections and respective accommodating seats.

In the preferred embodiment the shaped projections and the respective accommodating seats have complementary shapes, e.g. they are dovetail shaped. Alternatively, they can be circular, half-moon-shaped, mushroom-shaped, etc., as long as they allow to obtain a shape coupling as puzzle pieces, with a rule section side by side with the consecutive rule section.

Preferably, the method also comprises prior to step (a), the optional step of:

(a′) obtaining notches or recesses at the cutting edge of the cutting rule and/or at the creasing profile of the creasing rule.

In practice, it is advantageous to cut notches at the cutting edge of the cutting rules and/or at the creasing profile of the creasing rules, before the rules are sheared. The function of the notches is to ensure that the cutting edge of each sheared section of cutting rule and/or the creasing profile of each sheared section of creasing rule are not damaged right during shearing.

By taking care that shearing is performed so that the impression of the shearing tool intercepts the notches, rule sections having perfect cutting edges, with sharp corners without defects can be obtained and, similarly, rule sections having creasing profiles without defects can be obtained. This can be achieved by obtaining the notches at a distance of L on at least one between the cutting rule and the creasing rule, and by carrying out steps (a) and (b) by separating sections of cutting rule and sections of creasing rule which are between two consecutive notches.

Clearly, the notches can also be made with regular pitch, i.e. with constant distance L, but more frequently the notches have to be made with a pitch (and therefore a distance) that is not constant, because the cutting-creasing rule to be made is customized. The method can be carried out in both cases.

Step (a′) can be carried out by aligning the shearing tool each time with an edge of the notch at which either a section of the cutting rule is separated or a section of the creasing rule is separated. If the alignment is not set, along the upper profile of the cutting-creasing rule there will be chamfers, i.e. interruptions between the consecutive cutting edges and creasing profiles.

For example, step (a′) can be implemented with punching techniques, i.e. by using a punch or punching unit provided with several punches (and corresponding dies).

Preferably, step (a′) is implemented by using a punching tool positioned upstream of the shearing tool with respect to the feed direction of the cutting rules and the creasing rules in the same processing apparatus. This way, the shearing is subsequent to the formation of the notches.

Therefore, a second aspect of the present invention concerns an apparatus according to claim 13 for processing cutting-creasing rules for die-cutters.

In particular, the apparatus comprises at least one shearing tool and feeding means to feed cutting rules and creasing rules to the shearing tool. Advantageously, the impression or shearing shape defined by the shearing tool intercepts the cutting edge of the cutting rules and the creasing profile of the creasing rules each time they are subject to shearing, regardless of their height, i.e. the shearing tool is positioned with respect to the rule-feeding means so as to intercept anyway the upper edge of the rule each time brought under the shearing tool.

Other advantageous characteristics of the apparatus are described in claims 14-19.

### BRIEF LIST OF THE FIGURES

Further characteristics and advantages of the invention will be better highlighted by the review of the following detailed description of a preferred, but not exclusive, embodiment illustrated by way of example and without limitations, with the aid of the accompanying drawings, in which:

FIG. 1 is an elevation view of a cutting-creasing rule made with the method according to the present invention;

FIG. 2 is a perspective view of the cutting-creasing rule shown in FIG. 1;

FIG. 3 is an enlargement of FIG. 1;

FIG. 4 is a perspective view of a cutting rule processed according to the method of the present invention for making sections of cutting rule in order to assemble a cutting-creasing rule;

FIGS. 5-8 are elevation views of the cutting rule shown in FIG. 4, in which each of FIGS. 5-8 sequentially shows a further corresponding step of the method according to the present invention;

FIG. 9 is a perspective view of a punching unit of the apparatus according to the present invention, having the function to make notches according to a first step of the method of the present invention and to obtain the rule shown in FIG. 4;

FIG. 10 is an enlarged perspective view of a detail of the punching unit shown in FIG. 9;

FIG. 11 is a perspective and enlarged view of a detail of the punching unit shown in FIG. 9 during the processing of a cutting rule;

FIG. 12 is also a perspective and enlarged view of a detail of the punching unit shown in FIG. 9 during the processing of a cutting rule;

FIG. 13 is a perspective view of a shearing unit of the apparatus according to the present invention, intended to shear sections of cutting rule and sections of creasing rule;

FIG. 14 is a perspective and enlarged view of a detail of the shearing unit shown in FIG. 13;

FIG. 15 is a perspective and enlarged view of a detail of the shearing unit shown in FIG. 13 during the processing of a cutting rule;

FIG. 16 is a perspective and enlarged view of a detail of the shearing unit shown in FIG. 13 during the processing of a creasing rule.

### DETAILED DESCRIPTION OF THE INVENTION

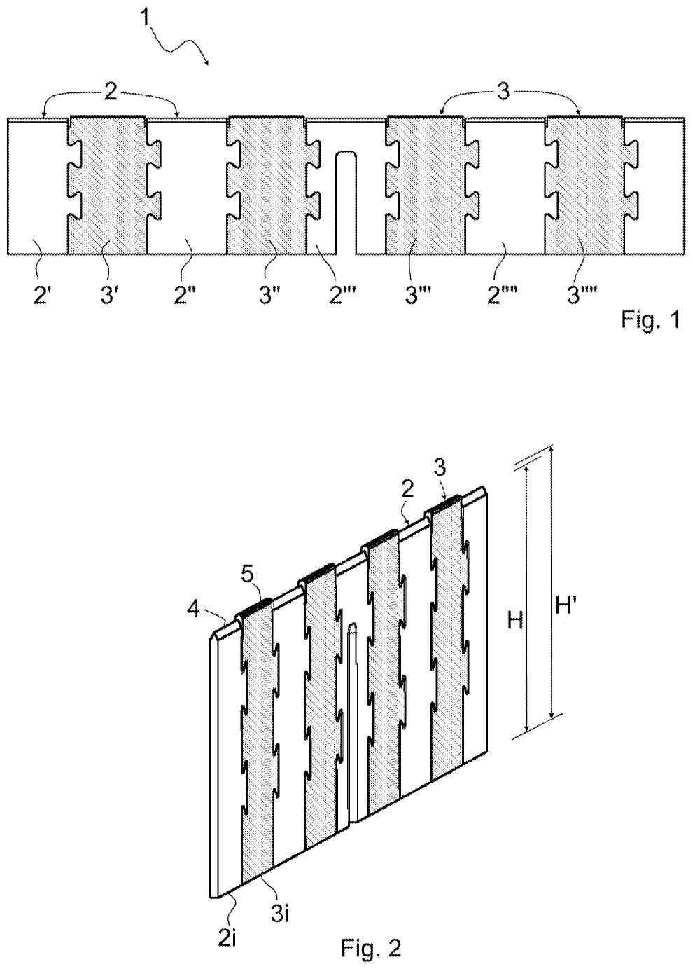

FIG. 1 shows a cutting-creasing rule 1 obtained by the method according to the present invention, intended to be mounted on a die-cutter. The rule 1 is finished and ready for use, i.e. it is ready to be received in a corresponding seat obtained by laser cutting in the die-cutter supporting plate.

The rule 1 is obtained by coupling in succession a plurality of sections 2′-2″″ sheared from a cutting rule 13, i.e. a rule 13 with a cutting edge 4, and a plurality of sections 3′-3″″ sheared from a creasing rule 14, i.e. a rule provided with an upper creasing edge 5, also called creasing profile 5. The sections 2′-2″″ of cutting rule are generally denoted by the reference number 2 and the sections 3′-3″″ of creasing rule are generally denoted by the reference number 3.

FIG. 2 shows the rule 1 perspectively. In this figure we can best appreciate the difference in the shape of the cutting edge 4 of the sections 2 of cutting rule, substantially wedge or knife shaped, and the shape of the upper edge 5 (also called upper profile) of the sections 3 of creasing rule, substantially rounded. All sections of cutting rule 2′-2″″ and all sections 3′-3″″ of creasing rule have height extending between a lower edge 2i, 3i and either the cutting edge 4 or the upper edge 5, respectively. In order for the rule 1 to be usable and to allow sheets of paper or cardboard to be die-cut with the desired dimensional accuracy, the height H, H′ of the rule sections 2 and 3 have to be precise and the lower edges 2i and 3i of all sections 2′-2″″ of cutting rule and all sections 3′-3″″ of creasing rule have to be perfectly aligned.

In the example shown in FIGS. 1 and 2, the cutting-creasing rule 1 consists of sections 2 of cutting rule alternated in succession with sections 3 of creasing rule, so that in the upper edge of the rule 1 there are cutting edges 4 alternated with upper creasing edges 5. The height H′ of the sections 3 of creasing rule is greater than the height H of the sections 2 of cutting rule, i.e. H′>H; this is only an example, since in general the rule 1 can be assembled by coupling sections 2 and 3 in which H′<H or H′ is substantially equal to H.

In the example shown in figures, the thickness of the rule sections 2 and 3, and therefore also the thickness of the finished rule 1, is equal to 0.71 mm, H=22 mm and H′=24 mm. The rule sections 2 and 3 are made of carbon steel.

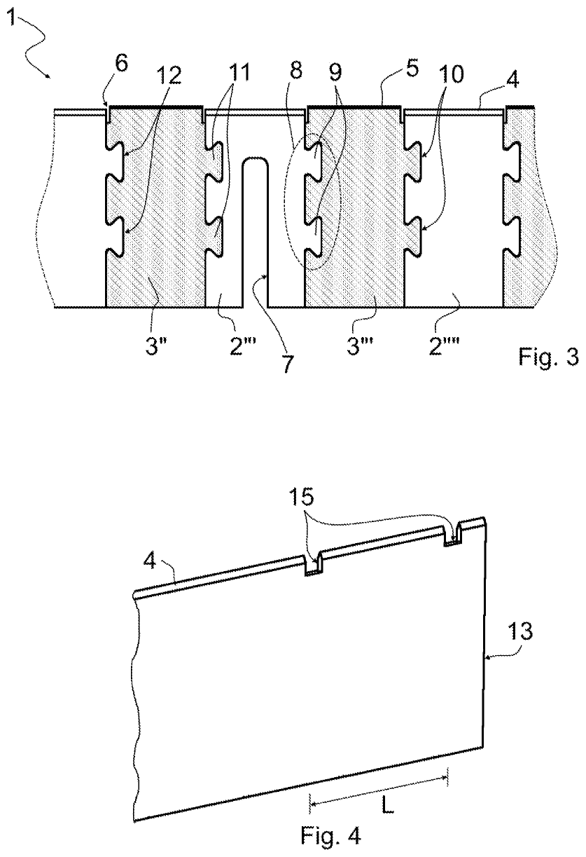

FIG. 3 is an enlargement of FIG. 1 that allows the following constructive details, however visible also in the FIGS. 1 and 2, to be best appreciated.

Between the cutting edge 4 of the sections 2 of cutting rule and the upper creasing edge 5 of the sections 3 of creasing rule, there are preferably chamfers 6, which can also be defined as indentations. In the example shown in figures, the chamfers 6 are obtained on the sections 3 of creasing rule, but in general they can also be obtained on the sections 2 of cutting rule or else on both types of rule sections 2 and 3. In practice, the chamfers 6 create a small gap between the cutting edges 4 and the upper creasing edges 5.

Another optional characteristic is the so-called bridge-like notch 7, which is obtained indifferently in the sections 2 or 3 of rule. The bridge-like notch 7 is designed to allow the insertion of the creasing-cutting rule 1 in the dedicated seat obtained in the die-cutter support, thereby preventing the rule 1 from interfering with the support of the die-cutter where the respective material has not been cut, i.e. where the accommodating seat of the rule 1 is locally interrupted. For example, if the die-cutter support is made of wood, thanks to the bridge-like notch 7 the length of the accommodating seat of the rule 1, where the wood has not been removed by laser, can be by-passed.

The reference number 8, on the other hand, generally denotes an essential construction detail, i.e. a shape coupling between the sections 2′-2″″ of cutting rule and the sections 3′-3″″ of creasing rule. In the example shown in the figures, the coupling 8 is obtained by making dovetail projections 9, 11 on the side edge of a rule section 2, 3 and, on the opposite side of the same rule sections 2, 3, a corresponding accommodating seat 10, 12 complementary shaped, to accommodate the projections 9, 11. This arrangement allows the sections 2 to be coupled to the sections 3 as pieces of a puzzle.

The specific shape of the coupling 8 shown in figures is not the only one possible, i.e. the figures show a non-restrictive embodiment, but in general the coupling 8 can also be obtained by making the projections 9, 11 and the corresponding accommodating seats 10, 12 having shapes different from the dovetail one, such as circular shapes, mushroom shapes, etc. The only precaution is that the projections 9, 11 and the corresponding accommodating seats 12, 10 have to be made so as to be complementary for the coupling: they have to allow the sections 2 and 3 to be effectively interlocked with each other in order to assemble the rule 1 without interruptions and with the sections 2 and 3 precisely aligned at the respective lower edges 2i, 3i.

The number of the projections 9, 11 and the corresponding accommodating seats 12, 10 can also be different from two for each side of the sections 2 and 3, as shown in the figures. For example, the coupling 8 can be obtained with a single projection 9 and a corresponding accommodating seat 12 having dovetail or mushroom or other suitable shape.

The method according to the invention that allows the cutting-creasing rule 1 to be obtained will be described hereafter.

The method provides for separating the sections 2′-2″″ from a cutting rule 13, for example of a commercially available type, and the sections 3′-3″″ from a creasing rule 14 (FIG. 16), for example of a commercially available type.

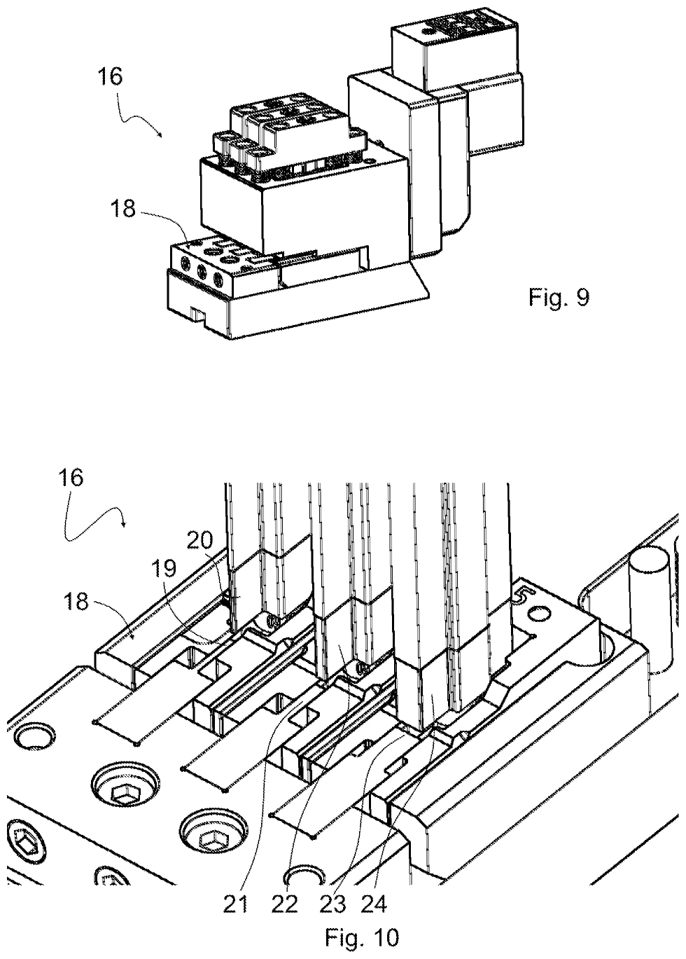

Optionally, before initiating this operation, the rules 13 and/or 14 are first processed in order to obtain the notches or recesses 15 shown in FIG. 4. The distance between the notches 15 corresponds to the length L of the sections 2′-2″″ of cutting rule and of the sections 3′-3″″ of creasing rule to be obtained. As will be described later, the notches 15 are preferably obtained with a punching unit 16, and more preferably with the cartridge unit 16 visible in FIGS. 9-12 which can be installed on an apparatus for processing rules 13, 14 for die-cutters according to the present invention.

FIG. 4 relates to this optional step: processing notches 15 on a cutting rule and/or on a creasing rule 14. In particular, FIG. 4 shows a cutting rule 13 on which 15 cuts have been made at a distance L from each other. If necessary, the same processing can be carried out on a creasing rule 14.

As described below, after creating the notches 15, an intermediate section between two notches 15 can be separated from the rule 13 or 14. The notches 15 are designed so that, during the separation of the sections 2′-2″″ of cutting rule and the sections 3′-3″″ of creasing rule, which provides that the rules 13, 14 are sheared, the cutting edges 4 of the sections 2′-2″″ of cutting rule and/or the upper creasing edges (profiles) 5 of the sections 3′-3″″ of creasing rule are prevented from being damaged, for example by being bent, weakened or broken at the corners. In addition, if when separating the sections 2′-2″″ and the sections 3′-3″″ from the respective rules 13, 14, a clearance is left between the cutting tool used and the edge of the notches, then the notches 15 can also be made to obtain the chamfers 6.

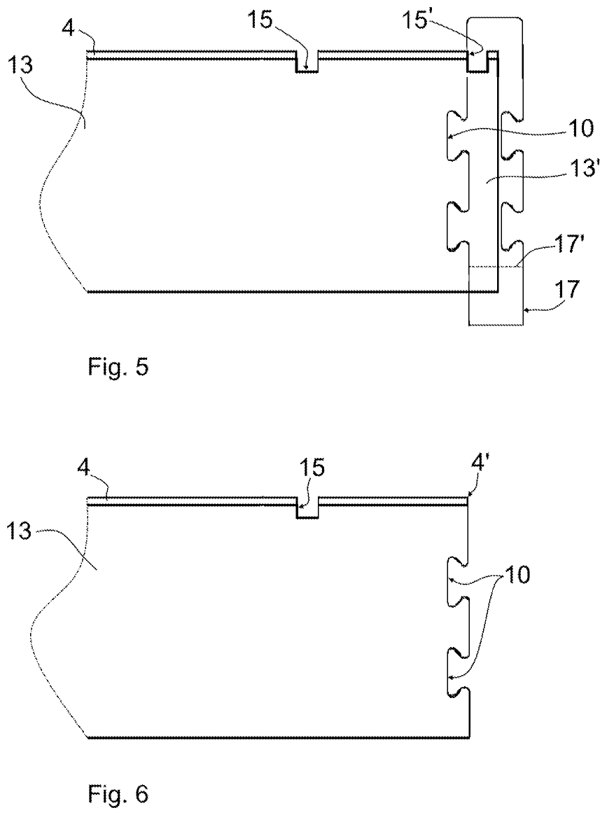

FIG. 5 shows a first step of the method according to the present invention: the cutting rule 13, which in the example described above was previously processed to obtain the optional notches 15, is subjected to further machining. The reference number 17 denotes the impression of a shearing tool 22 that, moving orthogonally to the rule 13, removes a portion 13′ thereof and creates at the same time the accommodating seats 10 to accommodate corresponding projections 11 of one of the sections 3′-3″″ of creasing rule. As described below, the shearing tool 27 is shown in FIGS. 14-16.

In particular, FIG. 5 shows a first (complete shearing) mode in which the impression 17 of the shearing tool 27 has height greater than the height of the cutting rule 13 and the creasing rule 14, or at least equal to the greater of the two. The shearing tool 27 is positioned with respect to the rules 13 and 14 which are each time sheared, so that the impression 17 encloses the height of the rules 13 and 14, i.e. so as to intercept the cutting edge 4 and the lower edge 2i of the cutting rule 13 and the creasing profile 5 and the lower edge 3i of the creasing rule.

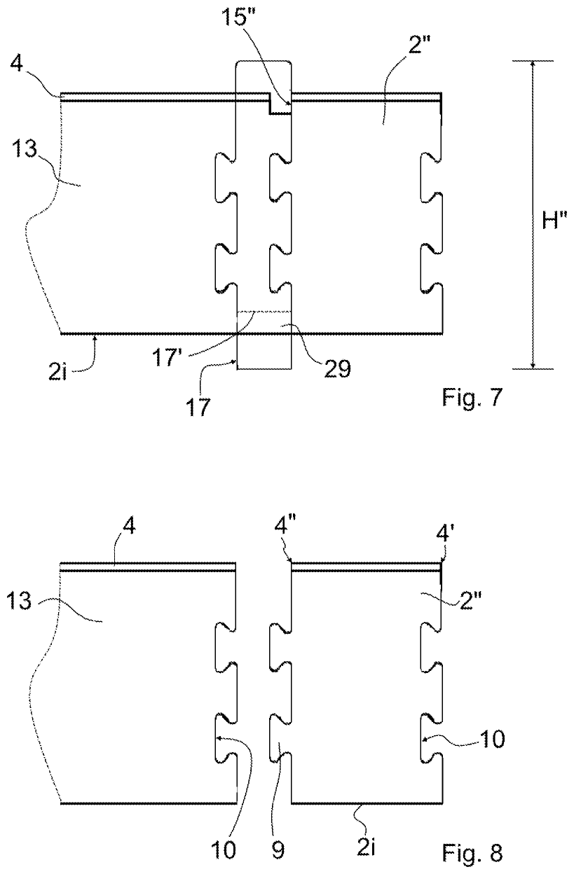

As described in the summary, this is not the only possible mode. In a second (partial shearing) mode, the impression 17′ of the shearing tool 27 intercepts the cutting edge 4 of the cutting rule 13 and the creasing profile 5 of the creasing rule, but does not intercept the lower edge 2i of the cutting rule 13 and the lower edge 3i of the creasing rule. Therefore, regardless of the height H″ of the impression 17, 17′, the cutting tool 27 partially separates the sections 2′-2″″ of cutting rule and the sections 3′-3″″ of creasing rule. In FIG. 7 the reference number 29 denotes the portion of rule 13 not sheared when using this second mode. The rules 13 and 14 remain intact at the respective lower edges 2i and 3i: the sections 2′-2″″ of cutting rule and the sections 3′-3″″ of creasing rule are definitely separated at a later time, for example by means of shears, downstream of the shearing tool 27 with respect to the feed direction of the rules 13, 14. This second mode, which does not depend on the height of the impression 17, is useful when the rules 13 and 14 have to be further machined between the partial shearing and the final cutting with the shears.

It should be noted that the shearing tool 27 is positioned with respect to the cutting rule 13 so that the impression 17 is aligned with the edge 15′ of the notch 15 further to the right, if any. If this does not happen, i.e. if the impression 17 is not aligned with the edge of the notch 15, the previously described chamfers 6 are obtained (which can be obtained on the sections 2′-2″″ of cutting rule and/or on the sections 3′-3″″ of creasing rule; FIG. 3 shows the case in which chamfers 6 are obtained on the sections 3′-3″″ of creasing rule).

FIG. 6 shows the result obtained after shearing the portion 13′, which is the first portion at the beginning of a new cutting rule 13: on the right edge, two dovetail seats 10 have been created to accommodate corresponding projections 11. Cutting edges 4 with the perfect sharp corner 4′, i.e. not damaged by the shearing, for example not bent, can be obtained thanks to the shearing of the portion 13′ carried out at the notch 15. In other words, the notches 15 allow the geometry of the cutting edges 4 to be preserved regardless of the depth and length of the notches 15.

FIG. 7 shows a second step subsequent to the first one: a section 2″ is separated from the cutting rule 13 by shearing again orthogonally to the rule 13 itself. As can be noted by observing the relative position of the impression 17 of the shearing tool 27 with respect to the rule 13, the shearing tool 27 is aligned with the edge 15″ of the only notch 15 left. As described above, this arrangement allows perfect corners 4′ of the cutting edge 4 to be obtained.

FIG. 7 shows the shearing of the section 2″ of cutting rule 4 according to the first mode, in which the height of the impression 17 of the shearing tool extends beyond both cutting edge 4 and the lower edge 2i. As mentioned above, if the second mode is preferred, in which the impression 17′ of the shearing tool 27 does not intercept the lower edge 2i of the rule 13, the section 2″ would be partially sheared, as the section 2″ would remain attached to the remaining part of the cutting rule 13 through the unsheared portion 29. The portion 29 would then be cut by shears at a later time.

FIG. 8 shows the result obtained after shearing the section 2″ from the cutting rule 13 by using the first mode, i.e. by completely shearing the section 2″: on the right edge there are two previously created dovetail seats 10 and on the left edge there are two dovetail projections 9 that can be interlockingly inserted into the corresponding accommodating seats 12 of one of the sections 3′-3″″ of creasing rule. In addition, the perfect corner 4″, i.e. not damaged by the shearing, for example not bent, can be obtained thanks to the shearing of the portion 2′ carried out at the notch 15.

The steps described are also carried out on a creasing rule 14, with the exception of the step of making the notches 15, which is preferential but optional, and can be performed on only one of the rules 13, 14, or both, depending on the need.

Having obtained the required sections 2′-2″″ of cutting rule and the required sections 3′-3″″ of creasing rule, the cutting-creasing rule 1 can be assembled by interlocking the sections with each other, for example manually, according to the desired sequence. Clearly, the method can be carried out to obtain sections 2′-2″″ of cutting rule and sections 3′-3″″ of creasing rule each having a given length, i.e. the length L of each section 2′-2″″ and 3′-3″″ can be selectively set, if necessary, in order to obtain sections of different length.

FIGS. 9-12 help to understand how the optional notches 15 can be obtained in practice. For simplicity, the figures show the case in which the notches 15 are obtained on a continuous cutting rule 13 but, alternatively or in addition, the same technique can be used, if necessary, to obtain the notches on a creasing rule 14 as mentioned above. In the example shown in the figures, the notches 15 are obtained with a cartridge unit 16 that punches the rules 13 and/or 14, i.e. a unit that can indifferently punch a cutting rule 13 and a creasing rule 14.

The cartridge unit 16 is an interchangeable unit of an apparatus for processing metal rules for die-cutters; an example of a cartridge unit, even if intended for other types of machining (for processing the so-called nicks which are different from the notches 15), is described in the European Patent EP 2851169 in the name of the Applicant.

The cartridge unit 16 is provided with a feed plane 18 for feeding the rules 13, 14. On the feed plane 18 a cutting rule 13 or a creasing rule 14 is fed each time, with intermittent movement, along a longitudinal direction (identified by the arrow in FIG. 12) corresponding to the lengthwise extent of the rule 13, 14. The intermittent motion is given by a special actuator (not shown), for example a pair of counter-rotating motorized rollers having the rule 13, 14 inserted in between and positioned upstream of the cartridge unit 16. The intermittent movement allows the rule 13, 14 to be fed so as to cover a distance corresponding to the length L shown in FIG. 4, then the rule is stopped and a notch 15 is made. For this purpose the cartridge unit 16 is provided with at least one punch 20 and a corresponding punching die 19. The punch 20 can be alternately moved along a direction orthogonal to the feed plane 18 of the rules 13, 14, while the punching die 19 is stationary and defines part of the plane 18. The combined action of the punch 20 and the corresponding punching die 19 allows a portion corresponding to a notch 15 to be cleanly cut from the rules 13, 14. When the unit 16 is activated, at a time when the rule 13, 14 is stationary, the punch 20 lowers on the rule 13 or 14 and passes through it, intercepting the die 19 on the opposite side of the rule 13, 14 with respect to the initial position of punch 20 itself.

As best shown in FIG. 10, preferably the cartridge unit 16 is provided with several die-punch pairs 21-22 and 23-24 to be able to make on the rules 13, 14 notches 15 of different sizes, for example more or less high or more or less long.

The actuator of the punches 20, 22 and 24 is not shown in the figures, for simplicity; for example it can be an actuator of the type described in EP 2851169.

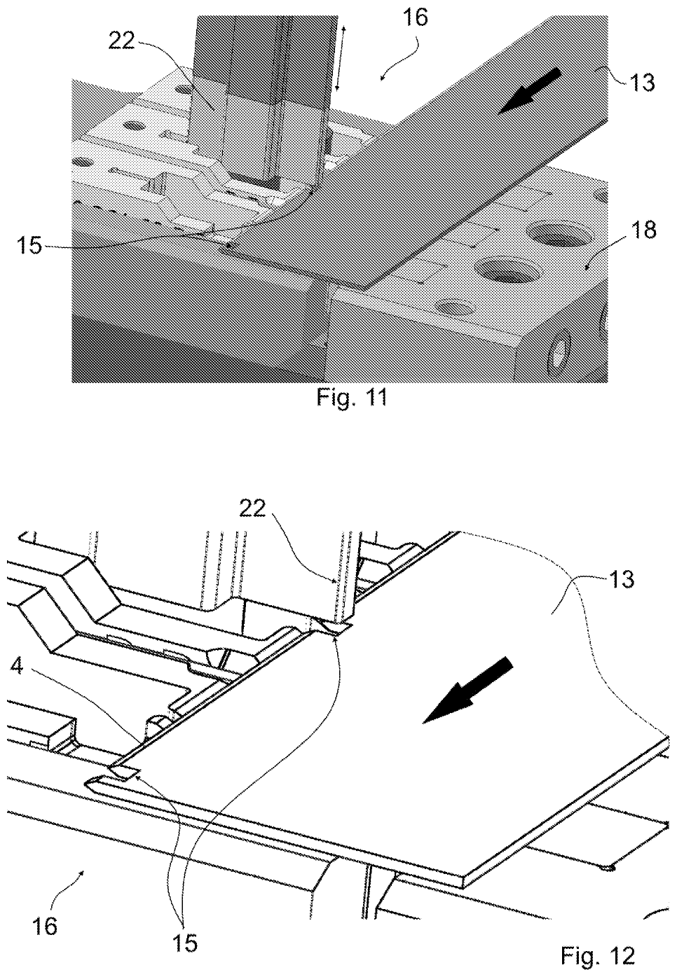

In particular, FIGS. 11 and 12 show the punch 22 having just made a notch 15 on a cutting rule 13 at a distance L from another notch 15 previously made, in order to obtain the rule 13 having the characteristics shown in FIGS. 4 and 5. The distance L is adjustable to selectively obtain sections 2′-2″″ of cutting rule each of the desired length.

As an alternative to punching, the notches 15 can also be performed with milling or grinding techniques. In this case, the cartridge unit 16 is replaced by a unit provided with one or more millers or grinding wheels that can be activated to remove material from the rules 13 or 14.

The technique described above can also be used to obtain the bridge-like notch 7 shown in FIG. 3.

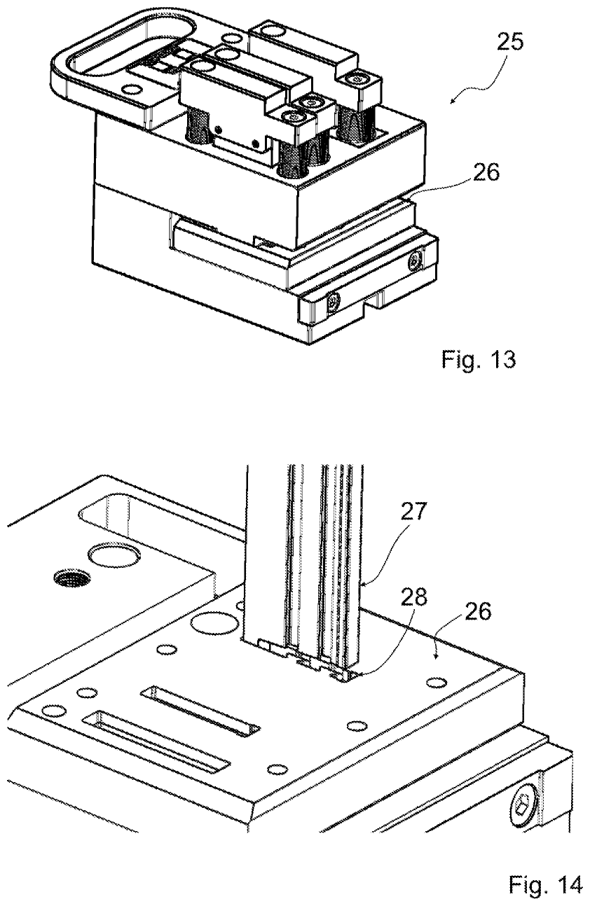

FIG. 13 shows a shearing unit 25 as a whole having the function of shearing the sections 2′-2″″ of cutting rule and the sections 3′-3″″ of creasing rule from the respective starting rules 13 and 14. As shown, also the unit 25 is preferably of the interchangeable-cartridge type.

FIG. 14 shows the inside of the unit 25, which is provided with a feed plane 26 for feeding the rules 13, 14: similarly to what described above as regards to unit 16, the rules slide on the plane 26 pushed with intermittent movement by a special actuator between a punching tool 27 and a corresponding punching die 28 of complementary shape. In the example shown in figures, the shearing tool 27 together with the die 28 define the impression 17 or 17′ shown in FIGS. 5 and 7: when the shearing tool 27 is at least partially inserted into the die 28, the complete separation (first mode) or partial separation (second mode) of the sections 2′-2″″ of cutting rule and sections 3′-3″″ of creasing rule is obtained.

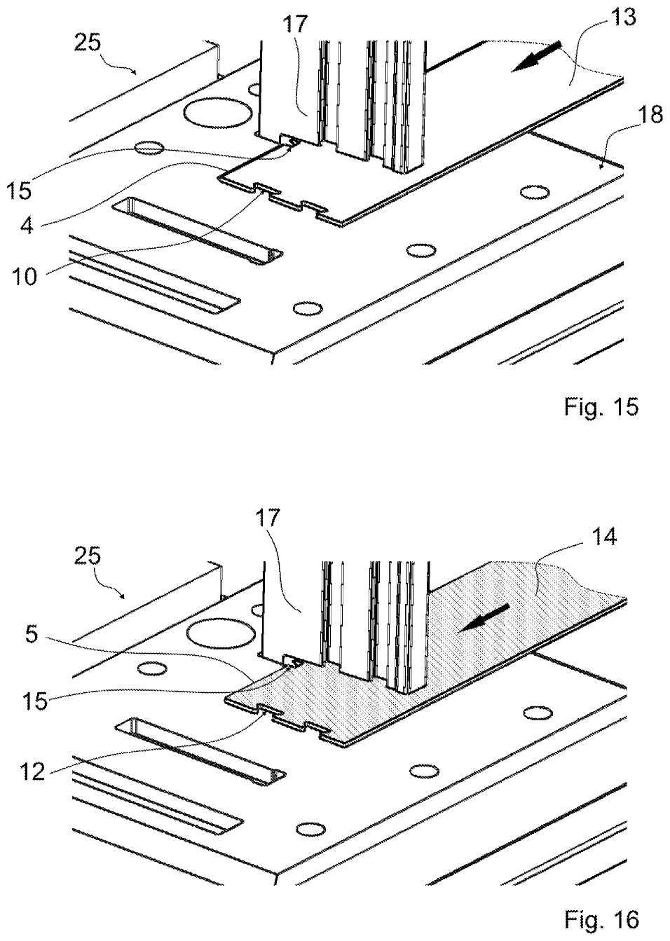

FIG. 15 shows the unit 25 when shearing a cutting rule 13 and FIG. 16 shows the same unit 25 when shearing a creasing rule 14, both in the first complete-shearing mode. The shearing tool 27 obtains the projections 9 and the dovetail seats 10 on the sections 2′-2″″ of cutting rule, and obtains the projections 11 and the dovetail seats 12 on the sections 3′-3″″ of creasing rule.

As described above, the method according to the present invention provides that the cutting rules 13 and the creasing rules 14 are sheared in the same unit 25 and not in different shearing units, as in traditional solutions. This provision allows an important result to be achieved: the perfect alignment of the sections 2′-2″″ of cutting rule with the sections 3′-3″″ of creasing rule. Using two different shearing units, one for the cutting rule 13 and the other for the creasing rule 14, it is assumed that the two rules 13, 14 are processed with different dimensional tolerances, precisely because the shearing tools would be different for the two rules 13, 14. On the other hand, using the same shearing unit 25 for both rules allows sections 2′-2″″ of cutting rule and sections 3′-3″″ of creasing rule with exactly the same dimensional tolerances to be obtained, which therefore can be perfectly assembled without inaccuracies of reciprocal positioning. This way, cutting-creasing rules 1 of excellent quality can be obtained, consisting of sections 2′-2″″ of cutting rule and sections 3′-3″″ of creasing rule which are able to be perfectly aligned and having cutting edges 4 and upper creasing edge 5 without defects.

In the preferred embodiment at least one between the cutting rule 13 and the creasing rule 14 is processed to obtain the notches 15. In this case, the punching unit 16 is positioned on the apparatus according to the present invention upstream of the punching unit 25, so that the rules 13, 14 first pass through the punching unit 16 and then through the shearing unit 25 without having to adapt the punching unit 25 to work on rules of different heights H, H′, exactly as usually happens with cutting rules 13 compared to creasing rules 14 to make a cutting-creasing rules 1. In other words, first the notches 15 are punched and then the sections 2′-2″″ of cutting rule and the sections 3′-3″″ of creasing rule are sheared.

Since the punching of the rules 13, 14 at the respective upper edge (cutting edge 4 and creasing profile 5) takes place in the apparatus before the rules 13, 14 enter the shearing unit 25, the latter can actually perform the shearing, i.e. the shaped cut, of both the cutting rules 13 and the creasing rules 14 regardless of their respective heights.

In fact, in the first mode, the impression 17 defined by the shearing tool 27 and the respective die 28 has higher height than both the rules 13, 14 and extends beyond the upper edges 4, 5 and the lower edges 2i, 3i of the rules 13, 14. Referring to FIG. 7, the height H″ of the impression 17 is greater than H and H′ (H″>H; H″>H′), or at least is equal to the greater of the two heights, which in the example shown in the figures is H′ (H″=H′). This characteristic allows the same shearing tool 27 to be used on both rules 13, 14 without having to replace the tool each time you switch from processing a cutting rule 13 to processing a creasing rule 14, or vice versa.

Alternatively, in the second mode, the impression 17′ of the shearing tool intercepts the upper edges 4, 5 of the rules 13, 14 but not the lower edges 2i, 3i, thereby leaving connecting portions 29 that are cut by shears downstream of the shearing (not shown).

As mentioned above, since always the same cutting tool 27 is used to process both the rules 13 and 14, it can be guaranteed that the sections 2′-2″″ of cutting rule and the sections 3′-3″″ obtained of creasing rule are straight and meet the required dimensional tolerances.

1. A method of making a cutting-creasing rule for die-cutters, comprising:
(a) from a cutting rule for die-cutters having height H, separating sections provided with a cutting edge and coupling to obtain a shape coupling with sections of a creasing rule;
(a) from a creasing rule for die-cutters having height H′, separating sections provided with a creasing profile and coupling to obtain a shape coupling with sections of a cutting rule; and
(c) coupling in succession said sections of the cutting rule to sections of creasing rule until the cutting-creasing rule is obtained,
wherein steps (a) and (b) are not carried out by tools different from each other for the cutting rule and the creasing rule, but by the same shearing tool whose impression, or shearing shape, intercepts the cutting edge of cutting rules and the creasing profile of creasing rules which are sheared.

2. The method according to claim 1, wherein the impression of the shearing tool has a height extending beyond both the cutting edge and the lower edge of the cutting rules and beyond both the creasing profile and the lower edge of the creasing rules, thereby enclosing the height of the rules.

3. The method according to claim 1, wherein the impression of the shearing tool, regardless of its height, intercepts the cutting edge of the cutting rules, but not the lower edge thereof, and intercepts the creasing profile of the creasing rules, but not the lower edge thereof, thereby leaving a connecting portion between the sections partially cut off from the respective rules and the remaining parts of the rules themselves, and wherein the connecting portion is subsequently cut.

4. The method according to claim 1, wherein steps (a) and (b) are carried out by using the same shearing unit provided with a plane for feeding or sliding the cutting rules and the creasing rules, a shearing tool which can be orthogonally moved with respect to the feed plane and a corresponding shearing die into which the shearing tool is inserted, wherein the shearing tool together with the shearing die define said impression that includes the side edges of both the sections of the cutting rules and the sections of the creasing rules as well as the respective coupling.

5. The method according to claim 1, wherein the coupling comprise shaped projections and respective accommodating seats.

6. The method according to claim 5, wherein the shaped projections and respective accommodating seats have complementary shapes.

7. The method according to claim 1, further comprising, prior to step (a), the step of:
(a′) obtaining notches or recesses at the cutting edge of the cutting rule and/or at the creasing profile of the creasing rule.

8. The method according to claim 7, wherein the notches are obtained at a distance L, and steps (a) and (b) are carried out by separating or partially separating sections of cutting rule and sections of creasing rule which are between two consecutive notches.

9. The method according to claim 7, wherein step (a′) is carried out by aligning the shearing tool each time with an edge of the notch at which either a section of the cutting rule is separated or a section of the creasing rule is separated.

10. The method according to claim 7, wherein the step (a′) is carried out by keeping the shearing tool each time at a distance from the edge of the notch at which a section of the cutting rule is separated or a section of the creasing rule is separated, in order to obtain a chamfer in the finished cutting-creasing rule.

11. The method according to claim 7, wherein step (a′) is implemented by punching techniques.

12. The method according to claim 7, wherein step (a′) is implemented by using a punching tool positioned upstream of the shearing tool with respect to a feed direction of the cutting rules and the creasing rules in the same processing apparatus.

13. An apparatus for processing cutting-creasing rules for die-cutters, comprising:
a shearing tool; and
feeding means to feed cutting rules and creasing rules to the shearing tool,
wherein an impression or shearing shape of the shearing tool intercepts the cutting edge of the cutting rules and a creasing profile of the creasing rules each time subject to shearing.

14. The apparatus according to claim 13, wherein:
the impression or shearing shape defined by the shearing tool has a height extending beyond both the cutting edge and the lower edge of the cutting rules and beyond both the creasing profile and the lower edge of the creasing rules, thereby enclosing the height of the rules; or
the impression of the shearing tool, regardless of its height, intercepts the cutting edge of the cutting rules, but not the lower edge thereof, and intercepts the creasing profile of the creasing rules, but not the lower edge thereof, thereby leaving a connecting portion between sections partially cut off from the respective rules and the remaining parts of the rules themselves.

15. The apparatus according to claim 13, wherein the shearing tool is part of a shearing unit provided with a plane for feeding or sliding the cutting rules and the creasing rules, and with a shearing die in which the shearing tool is inserted by being alternately moved orthogonal to the feed plane (26), and
wherein the shearing tool together with the shearing die define said impression that includes the side edges and coupling means to couple the sections of cutting rule and the sections of creasing rule, the sections being sheared or partially sheared.

16. The apparatus according to claim 15, wherein the coupling means comprise shaped projections and respective accommodating seats.

17. The apparatus according to claim 16, wherein the shaped projections and the respective accommodating seats have complementary shapes.

18. The apparatus according to claim 13, further comprising, upstream of the shearing tool with respect to the feed direction of the cutting rules and of the creasing rules, a punching tool that can be orthogonally moved with respect to a feed plane of the cutting rules and the creasing rules and designed to obtain notches or recesses at the cutting edge of the cutting rule and at the creasing profile of the creasing rule.

19. The apparatus according to claim 13, comprising feeding means to feed cutting rules and creasing rules to the shearing tool, and to a punching tool positioned upstream of the shearing tool, by intermittent straight movement, wherein between two consecutive stops the cutting rules and the creasing rules cover a distance corresponding to the length L of sections of cutting rule and of sections of creasing rule which are sheared.

20. The apparatus according to claim 17, wherein the shaped projections and the respective accommodating seats are dovetail shaped.
